(19) United States
(12) Patent Application Publication
(10) Pub. No.: US 2014/0055339 A1
(43) Pub. Date: Feb. 27, 2014

(54) ADAPTIVE VISUAL OUTPUT BASED ON MOTION COMPENSATION OF A MOBILE DEVICE

(71) Applicants: David Stanasolovich, Albuquerque, NM (US); Don G. Meyers, Rescue, CA (US); Joshua Boelter, Portland, OR (US); Sudip S. Chahal, Gold River, CA (US)

(72) Inventors: David Stanasolovich, Albuquerque, NM (US); Don G. Meyers, Rescue, CA (US); Joshua Boelter, Portland, OR (US); Sudip S. Chahal, Gold River, CA (US)

(21) Appl. No.: 13/592,298

(22) Filed: Aug. 22, 2012

(51) Int. Cl. G09G 5/00

(52) U.S. Cl. 345/156; 345/619

(57) ABSTRACT

Systems, storage medium, and methods associated with motion compensation of visual output on a mobile device are disclosed herein. In embodiments, a storage medium may have instructions to enable the mobile device to acquire data associated with motion of an environment in which the mobile device may be situated. The instructions may also enable the mobile device to calculate motion compensation for at least a portion of visual output of an application of the mobile device. The instruction may enable the mobile device to calculate motion compensation based at least in part on the data associated with motion, for use by the application to adapt at least the portion of visual output of the application. Other embodiments may be disclosed or claimed.

### TECHNICAL FIELD

This application relates to the technical field of data processing, more specifically to methods and apparatuses associated with adaptive visual output of a mobile device based on motion compensation.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A handheld device such as tablet, smartphone, or other mobile device may be very difficult to read or watch when the device is in motion. This includes when the user is reading or watching content on the device while traveling in a car, while walking, or while engaging in other human motion. Environmental motion caused by a car or the user is transferred to the mobile device, and the user's eyes have to try to follow the changing position of the content, e.g., reading material. For many people, focusing on moving words or images may cause nausea, especially while trying to read in a car.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an arrangement for adaptive visual output of a mobile device based on motion compensation;

FIG. 2 illustrates an operational diagram for motion compensation by the mobile device of FIG. 1;

FIG. 3 illustrates a method of performing motion compensation by the mobile device of FIG. 1;

FIG. 4 illustrates a method of operating the remote computing device of FIG. 1; and

FIG. 5 illustrates an example of a mobile device of FIG. 1; all arranged in accordance with embodiments of the present disclosure.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

Embodiments of the present disclosure may enable a mobile device such as a smartphone, tablet, notebook, or the like, to compensate for the environmental motion arising while the user of the mobile device is traveling in a vehicle, is walking, or is moving with the mobile device in some other manner.

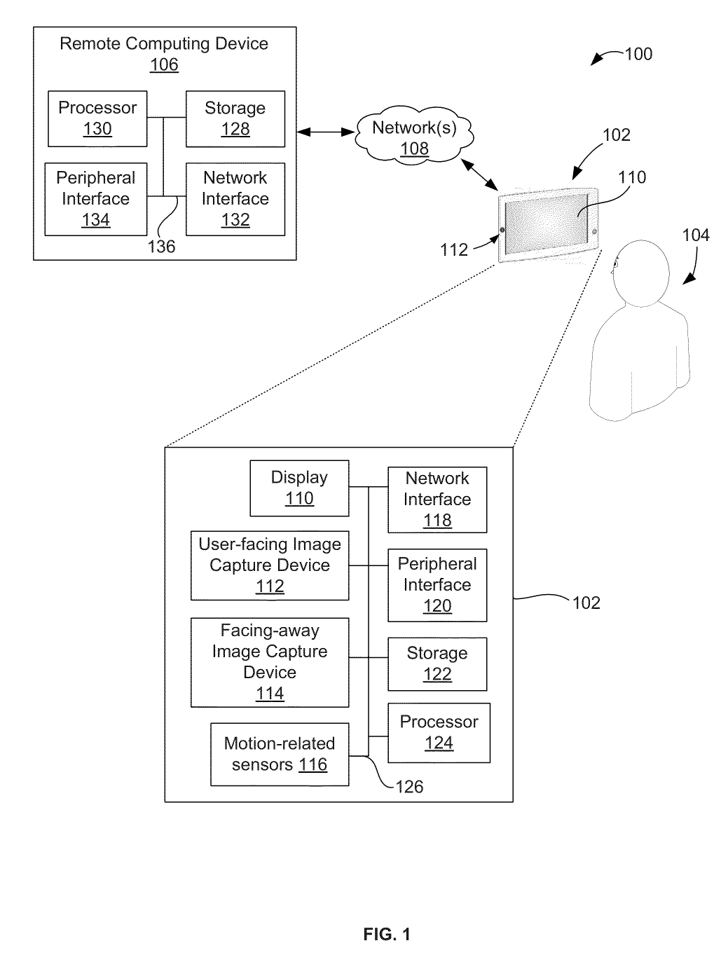

FIG. 1 illustrates a perspective view of a system 100 in which a mobile device is configured to adjust visual output of an application using motion compensation, and illustrates an example arrangement of the mobile device, in accordance with various embodiments. Visual output, as used herein, may refer to any visual information rendered or displayed by a mobile device and may include, user-interfaces, movies, applications, games, system utilities, documents, productivity tools, buttons, dialog windows, and the like. Motion compensation, as used herein, may refer to compensation of motion that is caused by or due to (but not limited to) the environment in which the mobile device is operated. This motion may be referred to as environmental motion. As illustrated, system 100 may include a mobile device 102 which may be operated and/or manipulated, by a user 104. Mobile device 102 may be communicatively coupled to remote computing device 106 via one or more networks 108.

According to embodiments, mobile device 102 may be configured to measure, in real-time, various characteristics of the environment in which mobile device 102 is being operated and acquire data associated with environmental motion. For example, mobile device 102 may be configured to measure acceleration, speed, vertical displacements (i.e., roughness of terrain), and lateral displacements by using one or more of accelerometer data, global positioning system (GPS) data, images of the surrounding landscape, and eye or face movement of user 104.

Mobile device 102 may be configured to use the various data associated with motion of an environment to calculate motion compensation for visual output rendered by mobile device 102. For example, mobile device 102 may be configured to use accelerometer data, GPS data, and image data to determine a pattern or frequency of movement or other environmental motion of mobile device 102. Mobile device 102 may be configured to compensate for movement or other environmental motion by adjusting visual output of mobile device 102. According to some embodiments, mobile device 102 may be configured to reduce or eliminate a frequency of movement or environmental motion.

Mobile device 102 may be configured to generate patterns based on accumulated data associated with environmental motion, i.e., historic motion characteristics, and use the patterns to estimate future environmental motion. Based on the estimated future environmental motion, mobile device 102 may be configured to proactively decrease the effects expected by the future environmental motion. For example, mobile device 102 may be configured to recall environmental motion data acquired during previous travels through a specific geographic terrain and implement a motion compensation scheme particular to the specific geographic terrain, e.g., to compensate for motion associated with traveling over a rocky road in a car.

Mobile device 102 may also be configured to use face-tracking or eye-tracking information while calculating motion compensation. For example, mobile device 102 may be configured to use face-tracking or eye-tracking information to determine motion of mobile device 102 relative to user 104 and compensate for the relative motion. According to other embodiments, mobile device 102 may use eye-tracking information to determine a current reading speed of user 104 and select between multiple alternate compensation calculations based on the determined reading speed. Once mobile device 102 calculates or determines environmental motion, mobile device may adjust visual output of mobile device 102 to improve the reading and/or interactive experience of user 104.

Mobile device 102 may include display device 110, user-facing image capture device 112, away-facing image capture device 112, motion-related sensors 116, a network interface 118, a peripheral interface 120, storage 122, and one or more processors 124, coupled with each other, via e.g., one or more communication buses 126.

Display 110 may be any one of a number of display technologies suitable for use on a mobile device. For example, display 110 may be a liquid crystal display (LCD), a thin-film transistor LCD, a plasma display, or the like. According to various embodiments, display 110 may be a touch sensitive display, i.e., a touchscreen. As a touchscreen, display 110 may be one of a number of types of touch screen, such as acoustic, capacitive, resistive, infrared, or the like.

User-facing image capture device 112 may be disposed on the mobile device 102 and oriented to face user 104. User-facing image capture device 112 may be configured to capture images from a user-facing direction. User-facing image capture device 112 may be a complimentary metal oxide semiconductor (CMOS) image sensor, a charge-coupled device (CCD) image sensor, or one or more antennas configured to construct or create images in response to received electromagnetic signals.

Away-facing image capture device 114 may be oriented towards a direction opposite to user 104. Image capture device 114 may be configured to optically capture images from an outward facing direction. Image capture device 114 may be a complimentary metal oxide semiconductor (CMOS) image sensor, a charge-coupled device (CCD) image sensor, or one or more antennas configured to construct or create images in response to received electromagnetic signals. According to embodiments, mobile device 102 may use away-facing image capture device 114 to capture images of portions of the environment facing away from user 104 and use the captured images to calculate motion compensation.

Motion-related sensors 116 may be configured to capture data related to environmental motion in various types of vehicles or modes of travel. As described above, briefly, motion-related sensors 116 may include accelerometer, a GPS unit, and the like. According to embodiments, antennas on mobile device 102 may be used to determine motion of mobile device 102 using triangulation techniques based on wirelessly received data. According to various embodiments, motion-related sensors 116 may be configured to acquire data associated with environmental motion caused by operation of mobile device 102 within any one of a variety of vehicles or transportation techniques. For example, motion-related sensors 116 may be configured to acquire data associated with environmental motion caused by traveling in a car, a truck, a train, an airplane, a boat, a ship, a mobile chair, a bicycle, a horse carriage, a motorcycle, and the like. According to other embodiments, motion-related sensors 116 may be configured to capture data related to environmental motion caused by walking, jogging, or running by user 104.

Network interface 118 may be configured to couple mobile device 102 to remote computing device 106 through one or more networks 108, hereinafter network 108. Network interface 118 may be a wireless local area network interface, such as a WiFi® interface in compliance with one of the IEEE 802.11 standards. (IEEE=Institute of Electrical and Electronics Engineers.) Network interface 118 may include a wireless wide area network interface, such as 3G or 4G telecommunication interface. (3G and 4G refer to the 3^{rd} and 4^{th} Generation of Mobil Telecommunication Standards as defined by International Telecommunication Union.)

Peripheral interface 120 may enable a variety of user interfaces, such as mice, keyboards, monitors, and/or audio commands. For example, peripheral interface 120 may enable USB ports, PS/2 ports, Firewire® ports, Bluetooth®, and the like, according to various embodiments.

Storage 122 may be volatile memory, non-volatile memory, and/or a combination of volatile memory and non-volatile memory. Storage 122 may also include optical, electro-magnetic and/or solid state storage. Storage 122 may store a plurality of instructions which, when executed by processor 124, may cause mobile device 102 to perform various functions related to motion compensation, as discussed above and as will be discussed below in further detail.

One or more processors 124 (hereinafter processor 124) may be configured to execute the plurality of instructions stored in storage 122. Processor 124 may be any one of a number of single or multi-core processors. In response to execution of the plurality of instructions, processor 124 may be configured to enable mobile device 102 to perform any one or more of the various functions disclosed herein. For example, processor 124 may be configured to cause mobile device 102 to acquire data associated with environmental motion using one or more of user-facing image capture device 112, facing-away image capture device 114, and motion-related sensors 116. Processor 124 may also be configured to calculate motion compensation and adjust visual output on display 110 to reduce or eliminate environmental motion and/or motion relative to user 104.

According to various embodiments, remote computing device 106 may be communicatively coupled to mobile device 102 via network 108. Remote computing device 106 may be located remotely from mobile device 102, such that each of remote computing device 106 and mobile device 102 are remote devices with respect to each other device. Remote computing device 106 may be configured to receive and store various data related to environmental motion and/or motion compensation from mobile device 102 and/or one or more devices that may be similar to mobile device 102. Remote computing device 106 may be configured to receive, via network 108, data from motion related sensors 116, data from user-facing image capture device 112, and/or data from facing-away image capture device 114. According to embodiments, remote computing device 106 may calculate motion compensation for visual output of mobile device 102 and may transmit the calculated motion compensation to mobile device 102. According to other embodiments, remote computing device 106 may accumulate various environmental motion data specific to various geographical locations and related to various modes of travel. Remote computing device 106 may then be configured to selectively provide environmental motion data to mobile device 102 or similar devices, in response to receiving a request for such information via the network 108.

Remote computing device 106 may include storage 128, processor 130, network interface 132, and peripheral interface 134.

Storage 128 may be volatile memory, non-volatile memory, and/or a combination of volatile memory and non-volatile memory. Storage 128 may also include optical, electro-magnetic and/or solid state storage. Storage 128 may store a plurality of instructions which, when executed by processor one or more processors 130, may cause remote computing device 102 to perform various functions related to supporting motion compensation in mobile device 102.

One or more processors 130 (hereinafter processor 130) may be configured to execute the plurality of instructions stored in storage 128. Processor 130 may be any one of a number of single or multi-core processors. In response to execution of the plurality of instructions, processor 130 may be configured to enable remote computing device 106 to perform any one or more of the various motion compensation-related functions disclosed herein. Processor 130 may be configured to cause remote computing device 130 to transfer data related to environmental motion and/or motion compensation to and/or from mobile device 102 via network 108.

Network interface 132 may be configured to couple remote computing device 106 to mobile device 102 through network 108. Network interface 132 may be a wireless local area network interface, such as a WiFi® interface in compliance with one of the IEEE 802.11 standards. (IEEE=Institute of Electrical and Electronics Engineers.) Network interface 132 may include a wireless wide area network interface, such as 3G or 4G telecommunication interface. (3G and 4G refer to the 3^{rd} and 4^{th} Generation of Mobil Telecommunication Standards as defined by International Telecommunication Union.)

Peripheral interface 134 may enable a variety of user interfaces, such as mice, keyboards, monitors, and/or audio commands. For example, peripheral interface 134 may enable USB ports, PS/2 ports, Firewire® ports, Bluetooth®, and the like, according to various embodiments.

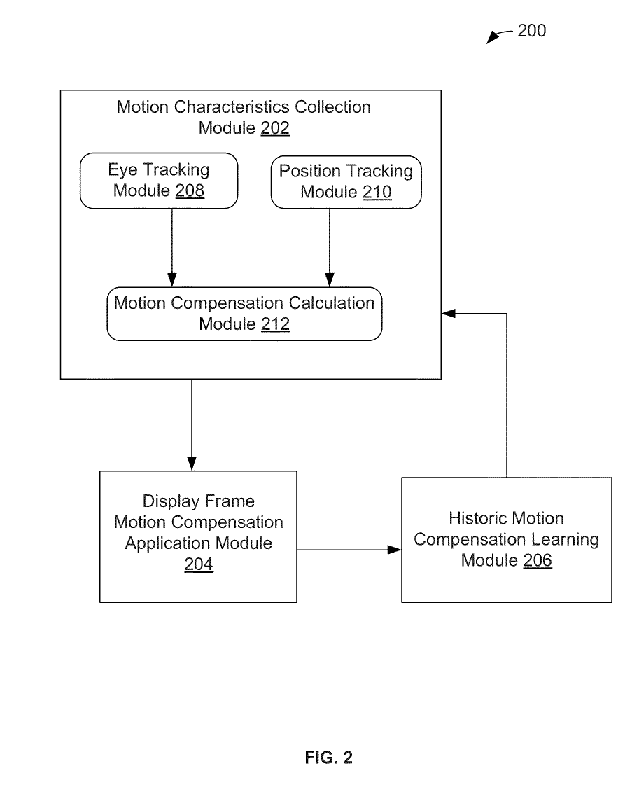

FIG. 2 illustrates an operational diagram 200 for motion compensation of mobile device 102, according to various embodiments. Diagram 200 includes a motion characteristics collection module 202, display frame motion compensation application module 204, and a historic motion compensation learning module 206, communicatively coupled with each other as shown.

Motion characteristics collection module 202 may be configured to collect various data and/or information about environmental motion in which mobile device 102 is operated. Motion characteristics collection module 202 may be configured to provide motion compensation calculations to display frame motion compensation application module 204. Motion characteristics collection module 202 may be configured to receive patterns or data related to historic motion compensation calculations from historic motion compensation learning module 206. Motion characteristics collection module 202 may include eye tracking module 208, position tracking module 210, and motion compensation calculation module 212. Eye tracking module 208 and position tracking module 210 may be configured to provide information to motion compensation calculation module 212.

Eye tracking module 208 may be a service or application configured to use images from user-facing image capture device 112 to track a face or eyes of a user, e.g. user 104. Eye tracking module 208 may be configured to track and orientation of the user's eyes or face relative to an orientation of a display 110 to enhance the calculations of motion compensation. Eye tracking module 208 may be configured to determine where on display 110 of mobile device 102 a user's eyes are focused and/or to determine a reading speed of user.

Position tracking module 210 may be a service or application configured to track the specific GPS or location coordinates, rate of movement, accelerometer data, and the like, of mobile device 102.

Motion compensation calculation module 212 may receive input data from eye tracking module 208 and position tracking module 210 and may be configured to calculate motion compensation based on the received input data. Motion compensation calculation module 212 may be a service or an application configured to calculate the real-time motion compensation, for example, by generating real-time motion compensation vectors. According to embodiments, motion compensation calculation module 212 may receive and use information from eye tracking module 208, position tracking module 210 and historic motion compensation learning module 206 to predictively calculate real-time motion compensation. The calculated motion compensation may be used to adjust visual output of display 110.

Display frame motion compensation application module 204 may be configured to receive motion compensation calculations from motion characteristics collection module 202. Display frame motion compensation application module may be a service or application that may be integrated into display 110 or other portions of mobile device 102 to apply motion compensation to visual output. Display frame motion compensation application module may be configured to adjust a portion of visual output display 110 independent of the overall movement of mobile device 102. Such adjustment may result in visual output that is stable and independent of environmental motion. According to some embodiments, display frame motion compensation application module 204 may apply motion compensation to all or to a portion of display 110. For example, motion compensation may be applied just to a portion of display 110 upon which the eyes of user 104 are focused.

Display frame motion compensation application module 204 may be selectively enabled by user 104. For example, mobile device 102 may continuously acquire environmental motion data and may continuously update patterns generated by historic motion compensation learning module 206 for a specific geographic location, mode of travel, and rate of travel. However, user 104 may selectively enable or disable display frame motion compensation application module 204, for example, via a switch, button, and/or user interface included in visual output of display 110.

Historic motion compensation learning module 206 may be a service or application configured to provide historical and cumulative learning or information about the motion characteristics, i.e., environmental motion, and motion compensation data collected and/or calculated for mobile device 102 while having a particular location and travel rate. For example, mobile device 102 may be operated during travels over a freeway, e.g., US10 in Phoenix, at 65 mph to have specific environmental motion or motion characteristics from which a particular set of motion compensation data or vectors may be generated. By contrast, mobile device 102 may be operated during travels on a two-lane road in the suburbs to have environmental motion or motion characteristics from which an entirely different set of motion compensation data or vectors may be generated. Historic motion compensation learning module 206 may receive motion compensation calculations from display frame motion compensation application module 204. Alternatively, historic motion compensation learning module 206 may receive motion compensation calculations directly from motion characteristics collection module 202. According to some embodiments, historic motion compensation learning module 206 may be enabled to operate independent of whether display frame motion compensation application module 204 is enabled.

Historic motion compensation learning module 206 may include a pattern recognition engine or other learning algorithm, such as the Hidden Markov Model, etc., as a core of the recognition engine or learning system. Other pattern recognition techniques, such as those known by one of ordinary skill in the art, may be applied. The pattern recognition engine or learning algorithm may be configured to analyze patterns in motion compensation calculations. The patterns may be used to estimate future environmental motion to support predictive motion compensation calculations. The pattern recognition engine or learning algorithm may be configured to analyze patterns in environmental motion that are caused in part by a user. For example, some environmental motion may be caused by a user's inability to hold a mobile device 102 steady while traveling in a vehicle, or during some other movement.

According to some embodiments, instructions for historic motion compensation learning module 206 may be stored locally on mobile device 102, e.g., in storage 122. According to other embodiments, instructions for historic motion compensation learning module 206 may be stored locally on mobile device 102 and/or remotely from mobile device 102. For example, instructions for historic motion compensation learning module 206 may be stored on remote computing device 106, e.g. in storage 128.

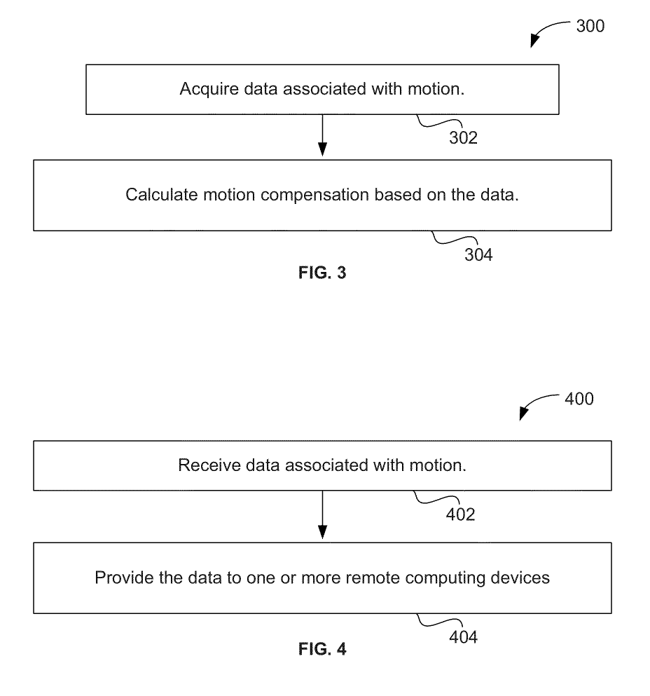

FIG. 3 illustrates a method 300 of operating mobile device 102 to compensate for environmental motion, according to various embodiments.

At block 302, mobile device 102 may acquire data associated with motion of mobile device 102. In particular, mobile device 102 may be configured to acquire data associated with motion of an environment in which mobile device 102 is situated and/or operated. The data associated with the motion of mobile device 102 may include accelerometer data, GPS data, and/or mode of travel data. Mode of travel data may indicate a mode of travel selected from a travel mode group. The travel mode group may include at least one of a car mode, a truck mode, a train mode, an air plane mode, a boat mode, a ship mode, a walking mode, a jogging mode, a running mode, a mobile chair mode, a bicycle mode, a horse carriage mode, and a motorcycle mode.

At block 304, mobile device 102 may calculate motion compensation based on the data acquired at block 302. In particular, mobile device 102 may calculate motion compensation for at least a portion of visual output of mobile device 102. Mobile device 102 may calculate motion compensation based on the acquired data and may calculate motion compensation to adapt a portion of visual output generated by the application.

Mobile device 102 may be configured to provide user 104 with the option of selecting an automatic mode or a manual mode. In automatic mode, mobile device 102 may automatically acquire environmental motion data and use a default setting for mode of travel based upon speed and geographic location of mobile device 102. In manual mode, mobile device 102 may request input from user 104. For example, mobile device 102 may receive input from user 104 related to geographic location, and mode of travel, terrain, and the like. According to some embodiments, mobile device 102 may be configured to request feedback from user 104 regarding whether user 104 perceives improvement in the visual output. Based on the feedback from user 104, mobile device 102 may require environmental motion data and/or re-calculate motion compensation.

According to one use scenario, mobile device 102 may be a tablet displaying visual output associated with an electronic book (ebook). User 104 may be reading visual output on mobile device 102 while sitting in the passenger seat of an automobile driving on a highway. As the car is moving, mobile device 102 and user 104 may be physically moving from environmental motion of the car. This environmental motion may be considered a reference movement or motion to be compensated for. Reading the visual output on mobile device 102 may be difficult while riding in the car because of the constant movement of display 110, which may be difficult to focus on. The constant movement of display 110 may also cause user 104 to become nauseous while trying to focus on the moving mobile device 102. User 104 may switch ON a motion compensation option of mobile device 102, in accordance with embodiments disclosed herein, and select a “vehicle motion” setting. According to method 300 and other disclosed embodiments, mobile device 102 may begin collecting motion data from the current motion environment. The collected motion data may include accelerometer data, GPS coordinate movement, eye and facial movement of user 104 as measured by user-facing image capture device 112, and the like. The collected motion data may also include surrounding environmental movement as measured by facing-away image capture device 114. Mobile device 102 may also access previously learned motion compensation data, i.e. historic motion compensation, for a user 104 at the current specific GPS location, and for the terrain associated with the acquired GPS location. Mobile device 102 may then calculate motion compensation in real-time, e.g., by calculating predictive motion compensation vectors. Mobile device 102 may use the calculated motion compensation to adjust visual output on display 110 (independent of a housing of mobile device 102). The adjusted visual output may offset, reduce, or minimize the overall image movement that user 104 perceives. User 104 may then be able to read in the car without becoming nauseous.

People may become more or less nauseous at particular frequencies of motion. For example, a vehicle and/or a mobile device moving at approximately 0.2 hertz may increase the discomfort experienced by user 104 while viewing mobile device 102. According to some embodiments, mobile device 102 may use the calculated motion compensation to adjust the visual output to increase a frequency of motion or decrease a frequency of motion to avoid a frequency of motion that may increase motion sickness or nausea experienced by user 104.

According to another use scenario, user 104 may be reading visual output on mobile device 102 while walking on a sidewalk. While user 104 is walking, user 104 and mobile device 102 may both be moving but may both be moving out of synchronization as user 104 attempts to hold mobile device 102 steady. The difference between the walking movement and the movement of mobile device 102 may be considered the reference movement to be compensated. Generally, walking may create enough environmental motion to make it difficult to focus on mobile device 102. User 104 may then switch ON a motion compensation option of mobile device 102 and select a “walking motion” setting. According to method 300 and other disclosed embodiments, mobile device 102 may begin collecting motion data from the current motion environment. Mobile device 102 may access historic motion compensation data, locally or remotely. Mobile device 102 may then calculate motion compensation in real-time, such as real-time predictive motion compensation vectors. Based on the calculated motion compensation, mobile device 102 may adjust the visual output on display 110 (independent of a housing of mobile device 102) to offset, reduce, or minimize the overall image movement that user 102 perceives. User 104 may then be able to read visual output from mobile device 102 with little or no reference movement or motion, i.e., little or no differential movement between the eye's of user 104 and the visual output of mobile device 102.

According to some embodiments, mobile device 102 may adjust a portion of the visual output of display 110 rather than all of the visual output. For example, mobile device 102 may determine, based on images captured from user-facing camera 112, that the eyes of user 104 are focused on a particular portion of the visual output, e.g., an upper left-hand corner of display 110. Mobile device 102 may be configured to adjust the particular portion of the visual output that is focused on without adjust the remaining portion of the visual output. Selectively focusing on portions of the visual output may decrease processing power by mobile device 102 and may extend the life of a battery or power supply of mobile device 102.

According to other embodiments, mobile device 102 may use eye-tracking features to improve motion compensation performance of mobile device 102. For example, eye-tracking features may enable mobile device 102 to improve characterization of environmental motion based on movement of the eyes of user 104 while attempting to focus on the visual output. As another example, eye or face tracking features may be used to identify the user and associate the acquired environmental motion and the calculated motion compensation with a particular user. Each user of mobile device 102 may select an account from which individual motion compensation settings and historic motion compensation and patterns may be retrieved.

FIG. 4 illustrates a method 400 of operating the remote computing device 106 to support motion compensation for mobile device 102.

At block 402, remote computing device 106 may receive data associated with motion. In particular, remote computing device 106 may receive data associated with motion in one or more environments from one or more computing devices that are located remotely from remote computing device 106, e.g., mobile device 102. Remote computing device 106 may receive environmental motion data from mobile device 102 and/or from other similar mobile devices operated by one or more users. Remote computing device 106 may receive environmental motion data through one or more networks, such as network 108. Remote computing device 106 may accumulate and store environmental motion data in a relational data structure, such as a database, and may associate burdensome environmental motion data with a corresponding geographical locations, terrain, and/or modes of travel.

At block 404, remote computing device 106 may provide the received data to the one or more computing devices. In particular, remote computing device 106 may provide the received data to one or more computing devices to enable the one or more computing devices to calculate motion compensation. The one or more computing devices may be configured to use the provided data to calculate motion compensation for all or a part of visual output rendered by the one or more computing devices.

In some embodiments, remote computing device 106 may be configured to calculate motion compensation based on the received data. Remote computing device 106 may then provide the calculated motion compensation to the one or more computing devices to enable the one or more computing devices to adjust the respective visual outputs to the respective environmental motion in which each of the one or more computing devices is operated. According to other embodiments, remote computing device 106 may be configured to determine and/or generate patterns based on the calculated motion compensation, the received data, or both. Remote computing device 106 may transmit or provide the determined patterns to the one or more computing devices to support motion compensation calculations by the one or more computing devices.

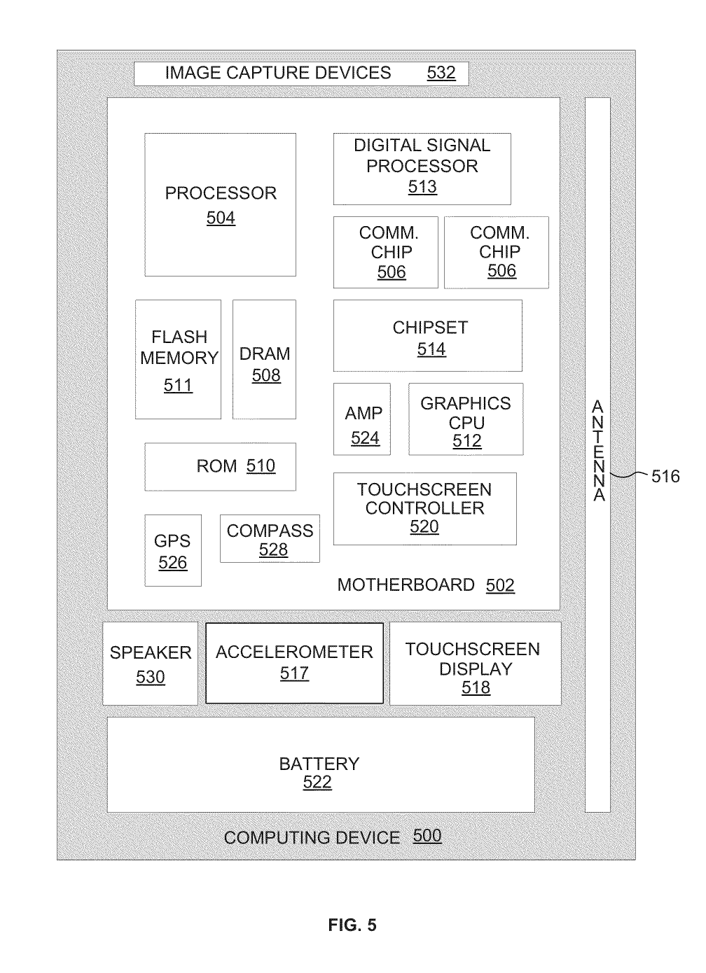

FIG. 5 illustrates a computing device 500 in accordance with one implementation of an embodiment of the invention. Depending on the actual components included, computing device 500 may be suitable for use as mobile device 102 or remote computing device 106 of FIG. 1. In embodiments, computing device 500 may house a motherboard 502. Motherboard 502 may include a number of components, including but not limited to a processor 504 and at least one communication chip 506. Processor 504 may be physically and electrically coupled to motherboard 502. In some implementations the at least one communication chip 506 may also be physically and electrically coupled to motherboard 502. In further implementations, the communication chip 506 may be part of the processor 504. In alternate embodiments, the above enumerated may be coupled together in alternate manners without employment of motherboard 502.

Depending on its applications, computing device 500 may include other components that may or may not be physically and electrically coupled to motherboard 502. These other components include, but are not limited to, volatile memory (e.g., DRAM 508), non-volatile memory (e.g., ROM 510), flash memory 511, a graphics processor 512, a digital signal processor 513, a crypto processor (not shown), a chipset 514, an antenna 516, a display (not shown), a touchscreen display 518, a touchscreen controller 520, a battery 522, an audio codec (not shown), a video codec (not shown), a power amplifier 524, a global positioning system (GPS) device 526, a compass 528, an accelerometer, a gyroscope, a speaker 530, user and away facing image capture devices 532, and a mass storage device (such as hard disk drive, compact disk (CD), digital versatile disk (DVD), and so forth).

In various embodiments, volatile memory (e.g., DRAM 508), non-volatile memory (e.g., ROM 510), and/or flash memory 511, may include instructions to be executed by processor 504, graphics processor 512, digital signal processor 513, and/or crypto processor, to practice various aspects of the methods and apparatuses described earlier with references to FIGS. 2-4 on mobile devices 102 and/or computing device 500.

The communication chip 506 may enable wired and/or wireless communications for the transfer of data to and from the computing device 500 through one or more networks. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 500 may include a plurality of communication chips 506. For instance, a first communication chip 506 may be dedicated to shorter range wireless communications such as Wi-Fi and Bluetooth and a second communication chip 506 may be dedicated to longer range wireless communications such as GPS, EDGE, GPRS, CDMA, WiMAX, LTE, Ev-DO, and others.

The processor 504 of the computing device 500 may include an integrated circuit die packaged within the processor 504. The term “processor” may refer to any device or portion of a device (e.g., a processor core) that processes electronic data from registers and/or memory to transform that electronic data into other electronic data that may be stored in registers and/or memory.

The communication chip 506 also includes an integrated circuit die packaged within the communication chip 506.

In further implementations, another component housed within the computing device 500 may contain an integrated circuit die that includes one or more devices, such as processor cores, cache and one or more memory controllers.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, an entertainment control unit, a digital camera, a portable music player, or a digital video recorder. In further implementations, the computing device 500 may be any other electronic device that processes data.

According to various embodiments, one or more computer-readable media may have instructions that may be configured to, in response to execution of the instructions by a mobile device, enable the mobile device to acquire data associated with motion of an environment in which the mobile device is situated, and calculate motion compensation for at least a portion of visual output of an application of the mobile device. The motion compensation calculation may be based at least in part on the data and may be for use by the application to adapt at least the portion of visual output of the application. The data associated with motion may include one or more of accelerometer data, global positioning system (GPS) data, and mode of travel data. The mode of travel data may indicate a mode of travel selected from a travel mode group having at least one of a car mode, a truck mode, a train mode, an airplane mode, a boat mode, a ship mode, a walking mode, a jogging mode, a running mode, a mobile chair mode, a bicycle mode, a horse carriage mode, and a motorcycle mode.

In embodiments, the instructions may be further configured to, in response to execution by the mobile device, enable the mobile device to determine a current focus of a user of the mobile device, and identify the portion of visual output of the application, based at least in part on the current focus. The instructions to enable the mobile device to determine may include instructions to receive real time captured images of the user, determine the current focus based at least in part on the real time captured images. The instructions may be configured, in response to execution of the instructions by the mobile device, to enable the mobile device to acquire at least some of the data associated with motion from the user. The instructions may be configured, in response to execution of the instructions by the mobile device, to enable the mobile device to adapt at least the portion of visual output of the application based at least in part on the motion compensation.

In embodiments, the instructions to enable the mobile device to calculate the motion compensation may include instructions to accumulate at least part of the data associated with motion in memory of the mobile device, and determine patterns for the motion compensation based on the data associated with motion that has been accumulated. The instructions may further be configured to, in response to execution by the mobile device, enable the mobile device to adapt at least the portion of visual output of the application based on the patterns.

According to embodiments, the instructions may be further configured to, in response to execution by the mobile device, enable the mobile device to acquire at least part of the data associated with motion of the environment in which the mobile device is situated from a remote computing device. The environment in which the mobile device is situated may be one of a plurality of environments in which the mobile device may be operable. The remote computing device may be configured to store the data associated with motion within the plurality of environments.

According to various embodiments, a method may include receiving, by sensors of a mobile device, data that is characteristic of an environment in which the mobile device is operated. The method may include determining, by the mobile device, motion compensation based on the data for a visual output displayed by the mobile device. The method may include accumulating the data as historic motion data in memory of the mobile device, and determining the motion compensation with a combination of the data that is received in real-time and the historic motion data. Determining the motion compensation may include determining, with the mobile device, patterns based on the data received in real-time and the historic motion data. The patterns approximate motion of the mobile device that may occur in the environment during operation of the mobile device. The method may include determining the motion compensation based on the patterns.

In embodiments, the method may include receiving, from a user, inputs to enable the mobile device to determine which of the historical motion data to use while determining the predictive motion compensation. The inputs may include one or more of a geographical location of operation of the mobile device, a rate of motion of the mobile device, and a type of vehicle within which the mobile device is operated. The data may include eye-tracking data of a user. The method may further include monitoring eye movements of a user based on images captured by an image capture device of the mobile device, and determining motion differences between one or more eyes of a user and the mobile device.

According to various embodiments, a mobile system may include a housing configured to carry one or more electronic circuits, a display coupled to the housing and configured to display visual output of an application of the mobile system, and a user-oriented image capture device carried by the housing. The mobile system may include memory carried by the housing and configured to store a number of instructions. The mobile system may include one or more processors configured, in response to execution of the instructions, to acquire data associated with motion of an environment in which the mobile device is situated, and to calculate motion compensation for at least a portion of the visual output, based at least in part on the data associated with motion, for use by the application to adapt at least the portion of the visual output of the application. The one or more processors may be further configured to, in response to execution of the instructions, monitor eye movement of a user, and identify at least the portion of the visual output based on said monitoring of the eye movement. The mobile system may be one of a smart phone, tablet computing device, laptop, netbook, and personal digital assistant. The display may be a touch screen display.

According to various embodiments, one or more computer-readable media may have instructions that may be configured to, in response to execution of the instructions by a computing device, enable the computing device to receive data associated with motion in one or more environments from one or more remote computing devices, and to provide the data to the one or more remote computing devices to enable the one or more remote computing devices to calculate motion compensation for at least a portion of visual output of an application of the one or more remote computing devices, for use by the application to adapt at least the portion of the visual output of the application.

In embodiments, the instructions may be further configured to, in response to execution by the computing device, enable the computing device to accumulate the data, determine patterns from the data to support calculations of motion compensation by the one or more remote computing devices, and provide the patterns with the data to the remote computing devices.

According to various embodiments, a computing device may include a network interface to communicate with one or more remote computing devices, memory to store the data and to store instructions, and one or more processors configured to, in response to execution of the instructions receive data associated with motion in one or more environments from one or more remote computing devices. The one or more processors may be configured to provide the data to the one or more remote computing devices to enable the one or more remote computing devices to calculate motion compensation for at least a portion of visual output of an application of the one or more remote computing devices, for use by the application to adapt at least the portion of the visual output of the application. The one or more processors may be configured to, in response to execution of the instructions, provide the data in response to a request for the data by the one or more remote computing devices. The one or more processors may be further configured to, in response to execution of the instructions, determine patterns of motion for each of the one or more environments based on the data received, and provide the patterns to the one or more remote computing devices.

According to various embodiments, each of the features described for each of the computer readable media, methods, and apparatus may be combined with other features of each of the computer readable media, methods, and apparatuses.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims.

What is claimed is:

1. One or more computer-readable media having instructions configured to, in response to execution of the instructions by a mobile device, enable the mobile device to:
acquire data associated with motion of an environment in which the mobile device is situated; and
calculate motion compensation for at least a portion of visual output of an application of the mobile device, based at least in part on the data, for use by the application to adapt at least the portion of visual output of the application.

2. The one or more computer-readable media of claim 1, wherein said data associated with motion includes one or more of accelerometer data, global positioning system (GPS) data, and mode of travel data.

3. The one or more computer-readable media of claim 2, wherein mode of travel data indicates a mode of travel selected from a travel mode group having at least one of a car mode, a truck mode, a train mode, an airplane mode, a boat mode, a ship mode, a walking mode, a jogging mode, a running mode, a mobile chair mode, a bicycle mode, a horse carriage mode, and a motorcycle mode.

4. The one or more computer-readable media of claim 1, wherein the instructions are further configured to, in response to execution by the mobile device, enable the mobile device to:
determine a current focus of a user of the mobile device; and
identify the portion of visual output of the application, based at least in part on the current focus.

5. The one or more computer-readable media of claim 4, wherein determine comprises:
receive real time captured images of the user; and
determine the current focus based at least in part on the real time captured images.

6. The one or more computer-readable media of claim 1, wherein the instructions are configured, in response to execution of the instructions by the mobile device, to enable the mobile device to acquire at least some of the data associated with motion from the user.

7. The one or more computer-readable media of claim 1, wherein the instructions are configured, in response to execution of the instructions by the mobile device, to enable the mobile device to adapt at least the portion of visual output of the application based at least in part on the motion compensation.

8. The one or more computer-readable media of claim 1, wherein calculate the motion compensation includes:
accumulate at least part of the data associated with motion in memory of the mobile device; and
determine patterns for the motion compensation based on the data associated with motion that has been accumulated.

9. The one or more computer-readable media of claim 8, wherein the instructions are further configured to, in response to execution by the mobile device, enable the mobile device to adapt at least the portion of visual output of the application based on the patterns.

10. The one or more computer-readable media of claim 1, wherein the instructions are further configured to, in response to execution by the mobile device, enable the mobile device to acquire at least part of the data associated with motion of the environment in which the mobile device is situated from a remote computing device, wherein the environment in which the mobile device is situated is one of a plurality of environments in which the mobile device is operable, wherein the remote computing device is configured to store the data associated with motion within the plurality of environments.

11. A method, comprising:
receiving, by sensors of a mobile device, data that is characteristic of an environment in which the mobile device is operated; and
determining, by the mobile device, motion compensation based on the data for a visual output displayed by the mobile device.

12. The method of claim 11, further comprising:
accumulating the data as historic motion data in memory of the mobile device; and
determining the motion compensation with a combination of the data that is received in real-time and the historic motion data.

13. The method of claim 12, wherein determining the motion compensation includes:
determining, with the mobile device, patterns based on the data received in real-time and the historic motion data, wherein the patterns approximate motion of the mobile device that may occur in the environment during operation of the mobile device; and
determining the motion compensation based on the patterns.

14. The method of claim 11, further comprising:
receiving, from a user, inputs to enable the mobile device to determine which of the historical motion data to use while determining the predictive motion compensation.

15. The method of claim 14, wherein the inputs include one or more of a geographical location of operation of the mobile device, a rate of motion of the mobile device, and a type of vehicle within which the mobile device is operated.

16. The method of claim 11, wherein the data includes eye-tracking data of a user, wherein the method further comprises:
monitoring eye movements of a user based on images captured by an image capture device of the mobile device; and
determining motion differences between one or more eyes of a user and the mobile device.

17. A mobile system, comprising:
a housing configured to carry one or more electronic circuits;
a display coupled to the housing and configured to display visual output of an application of the mobile system;
a user-oriented image capture device carried by the housing;
memory carried by the housing and configured to store a plurality of instructions; and
one or more processors configured, in response to execution of the instructions, to:
acquire data associated with motion of an environment in which the mobile device is situated; and
calculate motion compensation for at least a portion of the visual output, based at least in part on the data associated with motion, for use by the application to adapt at least the portion of the visual output of the application.

18. The mobile system of claim 17, wherein the one or more processors are further configured to, in response to execution of the instructions:
monitor eye movement of a user; and
identify at least the portion of the visual output based on said monitoring of the eye movement.

19. The mobile system of claim 17, wherein the mobile system is one of a smart phone, tablet computing device, laptop, netbook, and personal digital assistant.

20. The mobile system of claim 17, wherein the display is a touch screen display.

21. One or more computer-readable media having instructions configured to, in response to execution of the instructions by a computing device, enable the computing device to:
receive data associated with motion in one or more environments from one or more remote computing devices; and
provide the data to the one or more remote computing devices to enable the one or more remote computing devices to calculate motion compensation for at least a portion of visual output of an application of the one or more remote computing devices, for use by the application to adapt at least the portion of the visual output of the application.

22. The one or more computer-readable media of claim 21, wherein the instructions are further configured to, in response to execution by the computing device, enable the computing device to:
accumulate the data;
determine patterns from the data to support calculations of motion compensation by the one or more remote computing devices; and
provide the patterns with the data to the remote computing devices.

23. A computing device, comprising:
a network interface to communicate with one or more remote computing devices;
memory to store the data and to store instructions; and
one or more processors configured to, in response to execution of the instructions:
receive data associated with motion in one or more environments from one or more remote computing devices; and
provide the data to the one or more remote computing devices to enable the one or more remote computing devices to calculate motion compensation for at least a portion of visual output of an application of the one or more remote computing devices, for use by the application to adapt at least the portion of the visual output of the application.

24. The computing device of claim 23, wherein the one or more processors are configured to, in response to execution of the instructions, provide the data in response to a request for the data by the one or more remote computing devices.

25. The computing device of claim 23, wherein the one or more processors are further configured to, in response to execution of the instructions:
determine patterns of motion for each of the one or more environments based on the data received; and
provide the patterns to the one or more remote computing devices.
